(19) United States
(12) Patent Application Publication
(10) Pub. No.: US 2026/0371014 A1
(43) Pub. Date: Nov. 19, 2026

(54) Sound Generator

(71) Applicant: AAC Microtech (Changzhou) Co., Ltd., Changzhou City (CN)

(72) Inventors: Zhiwei Zhong, Changzhou (CN); Xiaodong Liu, Changzhou (CN); Xin Jin, Changzhou (CN); Wei Song, Changzhou (CN)

(21) Appl. No.: 19/317,189

(22) Filed: Sep. 3, 2025

Related U.S. Application Data
(63) Continuation of application No. PCT/CN2025/095158, filed on May 15, 2025.

(51) Int. Cl. H04R 9/06; H04R 7/04; H04R 9/02; H04R 9/04

(52) U.S. Cl. CPC H04R 9/06; H04R 7/04; H04R 9/025; H04R 9/046

(57) ABSTRACT

A sound generator is provided. The sound generator includes a frame; a vibration system with a diaphragm and a voice coil; and a magnetic circuit system with a yoke, a first magnetic portion stacked and fixed to the yoke, and a second magnetic portion. The sound generator further has an elastic conductive member having a first connecting portion, a second connecting portion, and an elastic portion. The first connecting portion is fixed to a side of the first magnetic portion away from the diaphragm, and the second connecting portion is electrically connected to the voice coil. The elastic portion has a U-shaped structure, extends through the first magnetic portion and is spaced apart from the first magnetic portion. Compared with related technology, the present invention has a long service life, saves installation space, and has excellent acoustic performance.

### TECHNICAL FIELD

The present invention relates to the field of electroacoustic transducer technology, particularly to a sound generator.

### BACKGROUND

With the development of electronic technology, portable consumer electronic products have become increasingly popular, such as mobile phones, handheld game consoles, navigation devices, or handheld multimedia entertainment devices. These electronic products generally use sound generators for system feedback, such as incoming call alerts, message notifications, navigation prompts, and vibration feedback for game consoles. The sound generator used in mobile phones has become one of the most important components.

The sound generator in the related art includes a frame, a vibration system fixed to the frame, and a magnetic circuit system driving the vibration system to vibrate. The vibration system includes a diaphragm fixed to the frame and a voice coil driving the diaphragm to vibrate and generate sound. The sound generator also includes an elastic connecting structure with one end fixed to the frame and the other end extending to one side of the voice coil and electrically connected to the voice coil.

However, in the related sound generator, the force arm portion of the elastic connecting structure has a planar structure, which maintains connection during vibration by utilizing excess line length force arm shear deformation. The planar structure not only has internal stress but also has shear stress from deformation, resulting in poor vibration performance.

Therefore, it is necessary to provide a new sound generator to solve the above technical problems.

### SUMMARY

At least one of the objects of the present invention is to provide a sound generator with long service life, space-saving installation, and excellent acoustic performance.

To achieve the above purposes, the present invention provides a sound generator, which includes: a frame; a vibration system including a diaphragm fixed to the frame and a voice coil configured to drive the diaphragm to vibrate and generate sound; a magnetic circuit system including a yoke fixed to a side of the frame away from the vibration system, a first magnetic portion stacked and fixed to a side of the yoke close to the diaphragm, and a second magnetic portion stacked and fixed to the side of the yoke close to the diaphragm and spaced apart from the first magnetic portion to form a magnetic gap; wherein the voice coil is inserted in the magnetic gap; and an elastic conductive member located at an inner side of the voice coil and extending through the first magnetic portion along a vibration direction of the diaphragm. The elastic conductive member includes a first connecting portion, a second connecting portion, and an elastic portion elastically connecting the first connecting portion and the second connecting portion. The first connecting portion and the second connecting portion are respectively disposed on opposite sides of the first magnetic portion along the vibration direction. The first connecting portion is fixed to a side of the first magnetic portion away from the diaphragm, while the second connecting portion is fixed to a side of the diaphragm close to the first magnetic portion and is electrically connected to the voice coil. The elastic portion has a U-shaped structure, the elastic portion extends through the first magnetic portion and is spaced apart from the first magnetic portion.

As an improvement of the invention described above, the sound generator further includes a through hole formed through the first magnetic portion, wherein the elastic portion is disposed in the through hole.

As an improvement of the invention described above, the elastic conductive member includes two elastic conductive members, the elastic portions of the two elastic conductive members are respectively disposed in the through hole, and opening directions of the two elastic portions are arranged oppositely along a long axis direction of the first magnetic portion.

As an improvement of the invention described above, the through hole includes a first through hole and a second through hole that extend through the first magnetic portion and are spaced apart along the long axis direction of the first magnetic portion; the elastic conductive member includes two elastic conductive members, the elastic portions of the two elastic conductive members are respectively disposed in the first through hole and the second through hole, and opening directions of the two elastic portions are arranged oppositely along the long axis direction of the first magnetic portion.

As an improvement of the invention described above, the voice coil includes a pair of oppositely disposed long axial sides and a pair of oppositely disposed short axial sides, at least one of the pair of long axial sides is recessed toward another long axial side to form a recessed portion; the first magnetic portion and the second magnetic portion are spaced apart to form the magnetic gap matching with the shape of the pair of long axial sides; the first through hole and the second through hole are respectively disposed on opposite sides of the recessed portion along the long axis direction of the first magnetic portion.

As an improvement of the invention described above, the first magnetic portion includes a main magnet stacked and fixed to the side of the yoke close to the diaphragm and a main pole piece stacked and fixed to a side of the main magnet close to the diaphragm; the elastic conductive member successively extends through the main pole piece and the main magnet.

As an improvement of the invention described above, the second magnetic portion includes an auxiliary magnet stacked and fixed to the side of the yoke close to the diaphragm and an auxiliary pole piece stacked and fixed to a side of the auxiliary magnet close to the diaphragm.

As an improvement of the invention described above, the auxiliary magnet includes four auxiliary magnets, and the four auxiliary magnets are spaced apart to form an annular structure, the four auxiliary magnets are respectively arranged around an outer periphery of the main magnet and spaced apart to form the magnetic gap.

As an improvement of the invention described above, the auxiliary magnet is annular and is arranged around the main magnet in a spaced manner.

As an improvement of the invention described above, the yoke includes a yoke body fixed to the frame and an avoidance hole formed through the yoke body, the avoidance hole communicates with the through hole; the sound generator further includes a sealing cover covering the through hole, the sealing cover and the first connecting portion are respectively disposed in the avoidance hole.

As an improvement of the invention described above, the elastic conductive member includes an elastic plate electrically connected to the voice coil and a transition assembly electrically connected to the elastic plate and fixed to a side of the first magnetic portion away from the diaphragm along the vibration direction, the transition assembly includes a conductive connecting member electrically connected to the elastic plate and a plastic seal injection-molded on the conductive connecting member, the elastic plate includes the second connecting portion, the elastic portion and a connecting end portion electrically connecting the elastic portion and the conductive connecting member, the connecting end portion and the transition assembly form the first connecting portion.

As an improvement of the invention described above, the plastic seal is fixed in the avoidance hole, a side of the plastic seal close to the sealing cover abuts against the sealing cover.

As an improvement of the invention described above, the yoke further includes a protruding portion extending from a side wall of the avoidance hole toward a mutually close side, the plastic seal and the protruding portion are integrally formed by injection molding.

As an improvement of the invention described above, the diaphragm includes an annular suspension, a fastening portion extending from an outer periphery of the suspension toward the frame, a vibration portion extending from an inner periphery of the suspension away from the frame, and a dome fixed to a side of the vibration portion close to the magnetic circuit system; the voice coil is fixed to a side of the dome close to the magnetic circuit system; the second connecting portion is fixed to the side of the dome close to the magnetic circuit system.

Compared with the prior art, in the sound generator of the present invention, by arranging the elastic conductive member at the inner side of the voice coil and extending through the first magnetic portion along the vibration direction of the diaphragm; the elastic conductive member including the first connecting portion, the second connecting portion, and the elastic portion elastically connecting the first connecting portion and the second connecting portion; the first connecting portion and the second connecting portion being respectively disposed on opposite sides of the first magnetic portion along the vibration direction, the first connecting portion being fixed to the side of the first magnetic portion away from the diaphragm, the second connecting portion being fixed to the side of the diaphragm close to the first magnetic portion and electrically connected to the voice coil; the elastic portion having a U-shaped structure and extending through the first magnetic portion while being spaced apart from the first magnetic portion; the stress received by the elastic portion during vibration is greatly reduced compared to a planar structure, significantly improving the vibration life of the elastic conductive member; meanwhile, the overall occupied planar space is greatly reduced, allowing for increased volume of other components and improved acoustic performance of the product.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a sound generator as described in embodiment one of the present invention;

FIG. 2 is an exploded view of the sound generator in FIG. 1;

FIG. 3 is a cross-sectional view of the sound generator, taken along line A-A in FIG. 1;

FIG. 4 is an isometric view of a sound generator in accordance with embodiment two of the present invention;

FIG. 5 is an exploded view of the sound generator in FIG. 4;

FIG. 6 is a cross-sectional view of the sound generator, taken along line B-B in FIG. 4;

FIG. 7 is an isometric view of a sound generator in accordance with embodiment three of the present invention;

FIG. 8 is an exploded view of the sound generator in FIG. 7;

FIG. 9 is isometric view of a sound generator in accordance with embodiment four of the present invention;

FIG. 10 is a cross-sectional view of the sound generator, taken along line C-C in FIG. 9;

FIG. 11 is a partial exploded view of the sound generator according in FIG. 9.

### DETAILED DESCRIPTION OF THE EMBODIMENTS

The following will be taken in conjunction with the accompanying drawings of embodiments of the present invention, The technical scheme in the embodiments of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

### Embodiment One

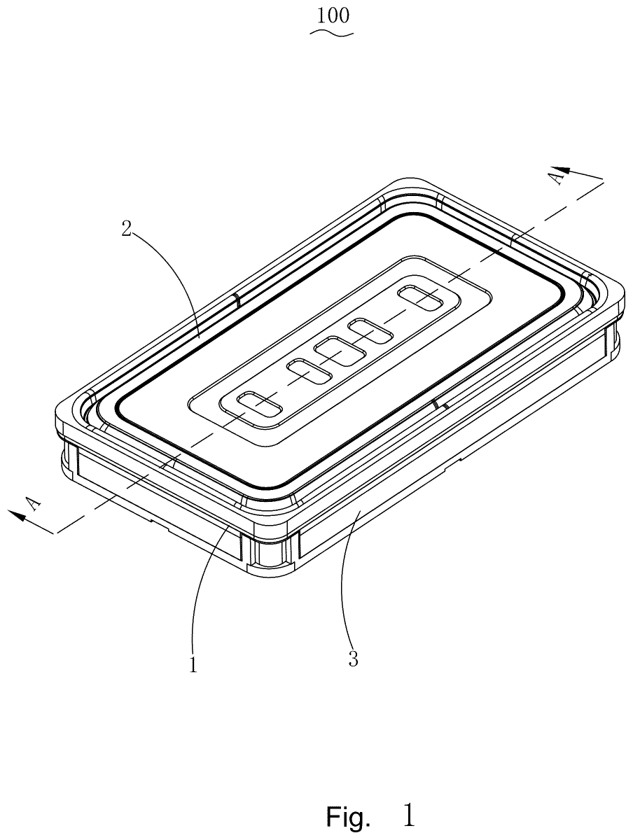

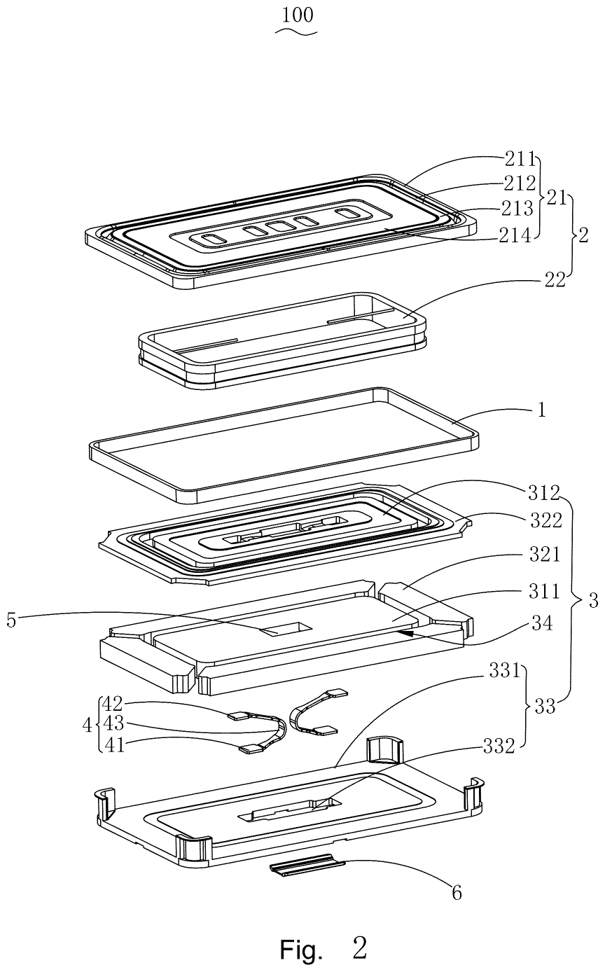

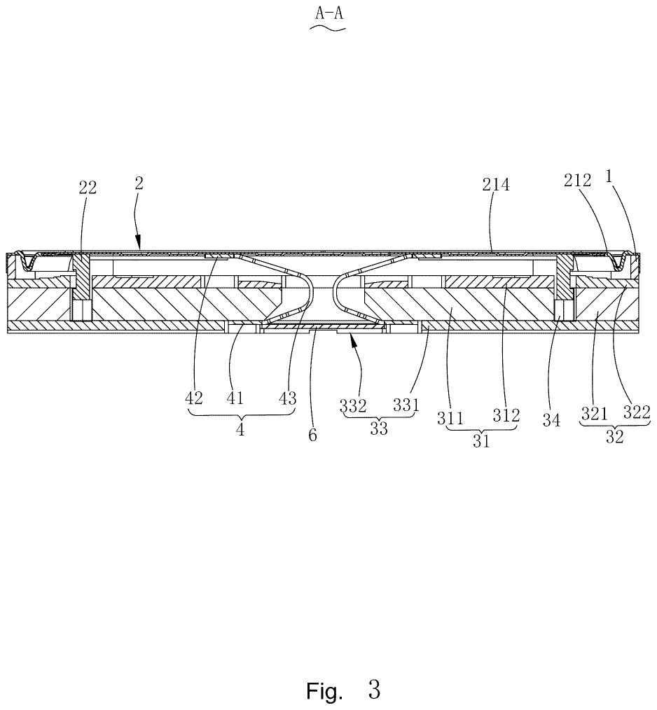

Please refer to FIGS. 1-3, the present invention provides a sound generator 100, including: a frame 1, a vibration system 2, and a magnetic circuit system 3.

The frame 1 is used to support and fix the vibration system 2 and the magnetic circuit system 3, providing supporting performance.

The vibration system 2 includes a diaphragm 21 fixed to the frame 1 and a voice coil 22 configured to drive the diaphragm 21 to vibrate and generate sound.

The magnetic circuit system 3 includes a yoke 33 fixed to a side of the frame 1 away from the vibration system 2, a first magnetic portion 31 stacked and fixed to a side of the yoke 33 close to the diaphragm 21, and a second magnetic portion 32 stacked and fixed to the side of the yoke 33 close to the diaphragm 21 and spaced apart from the first magnetic portion 31 to form a magnetic gap 34; the voice coil 22 is inserted in the magnetic gap 34. The yoke 33 is used to stack, mount and fix the first magnetic portion 31 and the second magnetic portion 32. The magnetic gap 34 formed between the first magnetic portion 31 and the second magnetic portion 32 works with the energized voice coil 22 to drive the diaphragm 21 to vibrate and generate sound, improving the acoustic performance of the sound generator 100.

The sound generator 100 further includes an elastic conductive member 4 located at an inner side of the voice coil 22 and extending through the first magnetic portion 31 along the vibration direction of the diaphragm 21. The elastic conductive member 4 includes a first connecting portion 41, a second connecting portion 42, and an elastic portion 43 elastically connecting the first connecting portion 41 and the second connecting portion 42; the first connecting portion 41 and the second connecting portion 42 are respectively disposed on opposite sides of the first magnetic portion 31 along the vibration direction, the first connecting portion 41 is fixed to a side of the first magnetic portion 31 away from the diaphragm 21, the second connecting portion 42 is fixed to a side of the diaphragm 21 close to the first magnetic portion 31 and is electrically connected to the voice coil 22; the elastic portion 43 has a U-shaped structure and extends through the first magnetic portion 31 while being spaced apart from the first magnetic portion 31. This enables the first connecting portion 41, second connecting portion 42 and elastic portion 43 to form a three-dimensional connecting structure, maintaining connection during vibration through elastic deformation of the elastic portion 43, with the three-dimensional structure having only internal deformation stress, greatly improving vibration life. During vibration of the sound generator 100, the first connecting portion 41 and second connecting portion 42 open and close vertically, and the stress received by the elastic portion 43 is greatly reduced compared to a planar structure, significantly improving the vibration life of the elastic conductive member 4; meanwhile, the overall occupied planar space is greatly reduced, allowing for increased volume of other components and improved acoustic performance of the product.

Specifically, the three-dimensional structure elastic conductive member 4 is used in combination with a single voice coil, with the elastic conductive member 4 arranged at the inner side of the voice coil 22. Various materials of the elastic conductive member 4, various three-dimensional force arm shapes, and corresponding various voice coil 22 shapes and magnetic circuit structures are all included.

In this embodiment, the first magnetic portion 31 and the second magnetic portion 32 can be made of permanent magnets or magnetic conductive materials. When audio current passes through the voice coil 22, the voice coil 22 experiences Ampere force in the magnetic field generated by the first magnetic portion 31 and the second magnetic portion 32, thereby producing vibration. This vibration is transmitted to the external environment through the diaphragm 21 connected to the voice coil 22, thus generating sound.

In this embodiment, the elastic portion 43 can also be V-shaped, C-shaped, and is not limited to these shapes. As long as it has an arc shape or similar arc shape that can provide elastic opening and closing movement along the vibration direction, it is considered as the U-shaped structure referred to in this embodiment. It connects the first connecting portion 41 and the second connecting portion 42 that are not in the same plane, and provides elastic supporting force.

In this embodiment, the sound generator 100 further includes a through hole 5 formed through the first magnetic portion 31, with the elastic portion 43 disposed in the through hole 5. The through hole 5 facilitates the elastic conductive member 4 to pass through the first magnetic portion 31. The first connecting portion 41 of the elastic conductive member 4 is fixed to the side of the first magnetic portion 31 away from the diaphragm 21, and the second connecting portion 42 is fixed to the side close to the first magnetic portion 31. When the voice coil 22 drives the diaphragm 21 to vibrate, the stress received by the elastic portion 43 is greatly reduced compared to a planar structure, significantly improving vibration life.

In this embodiment, there are two elastic conductive members 4, and the elastic portions 43 of the two elastic conductive members 4 are respectively disposed in the through hole 5, with their opening directions arranged oppositely along the long axis direction of the first magnetic portion 31. The two elastic conductive members 4 can further enhance the elastic support capability of the diaphragm 21, thereby increasing the service life of the elastic conductive members 4.

In this embodiment, the first magnetic portion 31 includes a main magnet 311 stacked and fixed to the side of the yoke 33 close to the diaphragm 21 and a main pole piece 312 stacked and fixed to the side of the main magnet 311 close to the diaphragm 21; the elastic conductive member 4 successively extends through the main pole piece 312 and the main magnet 311. The main pole piece 312 conducts the magnetic field of the main magnet 311, thereby facilitating the enhancement of the overall magnetic field strength of the main magnet 311.

In this embodiment, the second magnetic portion 32 includes an auxiliary magnet 321 stacked and fixed to the side of the yoke 33 close to the diaphragm 21 and an auxiliary pole piece 322 stacked and fixed to the side of the auxiliary magnet 321 close to the diaphragm 21. This facilitates increasing the magnetic field strength of the auxiliary magnet 321.

In this embodiment, there are four auxiliary magnets 321, and the four auxiliary magnets 321 are spaced apart to form an annular structure, with the four auxiliary magnets 321 respectively arranged around the outer periphery of the main magnet 311 and spaced apart to form the magnetic gap 34. Arranging the four auxiliary magnets 321 around the outer periphery of the main magnet 311 forms an annular magnetic gap 34, enhancing the overall magnetic field of the magnetic circuit system 3 and facilitating the driving of the voice coil 22.

In this embodiment, the yoke 33 includes a yoke body 331 fixed to the frame 1 and an avoidance hole 332 formed through the yoke body 331, with the avoidance hole 332 communicating with the through hole 5. The sound generator 100 further includes a sealing cover 6, with the sealing cover 6 and the first connecting portion 41 respectively disposed in the avoidance hole 332, and the sealing cover 6 fixed by covering the through hole 5. This facilitates the sealing cover 6 passing through the avoidance hole 332 and being fixed to cover the through hole 5, achieving sealing of the through hole 5 and providing overall protection. Meanwhile, part of the avoidance hole 332 covers the groove 323, while the first connecting portion 41 is installed on both sides of the groove 323, making it convenient for the first connecting portion 41 to connect with external power supply, conducting electrical signals successively through the first connecting portion 41, elastic portion 43, and second connecting portion 42 to the second connecting portion 42, facilitating the connection between the second connecting portion 42 and the voice coil 22 for power supply.

In this embodiment, the diaphragm 21 includes an annular suspension 212, a fastening portion 211 extending from the outer periphery of the suspension 212 toward the frame 1, a vibration portion 213 extending from the inner periphery of the suspension 212 away from the frame 1, and a dome 214 fixed to the side of the vibration portion 213 close to the magnetic circuit system 3; the voice coil 22 is fixed to the side of the dome 214 close to the magnetic circuit system 3; the second connecting portion 42 is fixed to the side of the dome 214 close to the magnetic circuit system 3.

### Embodiment Two

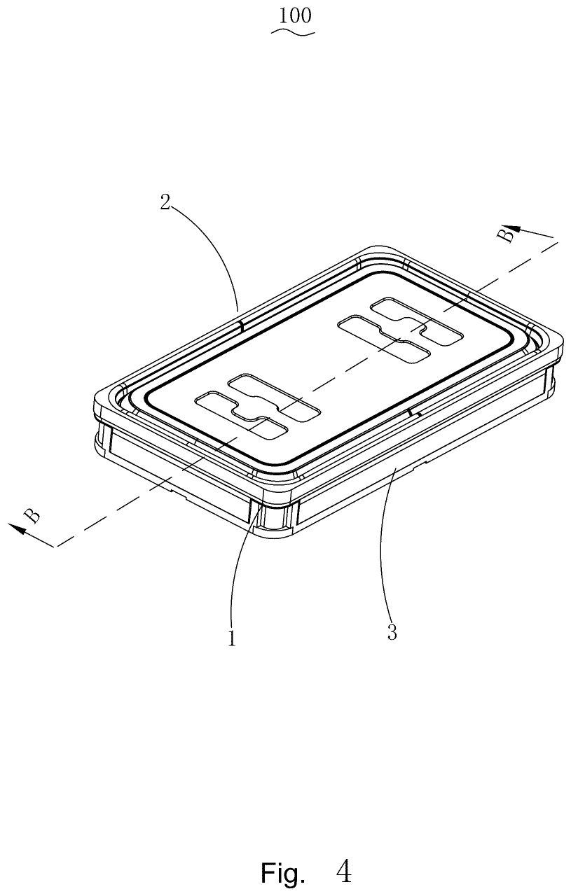

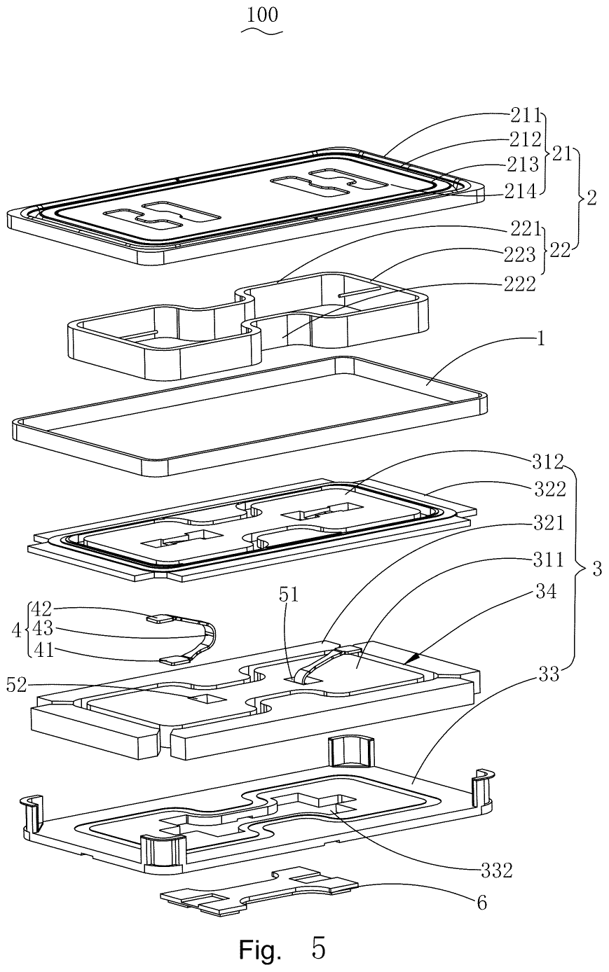

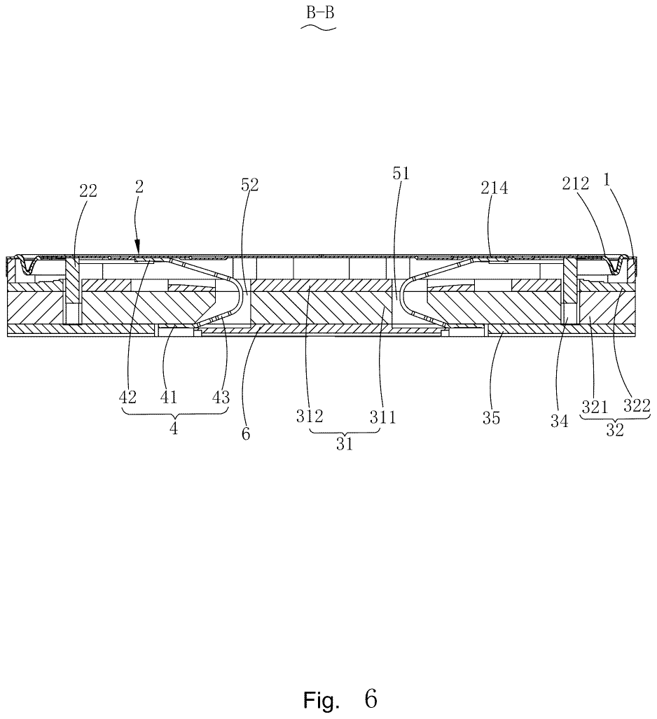

Please refer to FIGS. 4-6, this embodiment two is basically the same as embodiment one in structure, with the difference being that in this embodiment, the through hole 5 includes a first through hole 51 and a second through hole 52 that extend through the first magnetic portion 31 and are spaced apart along the long axis direction of the first magnetic portion 31. The elastic conductive member 4 includes two elastic conductive members, the elastic portions 43 of the two elastic conductive members 4 are respectively disposed in the first through hole 51 and the second through hole 52, and opening directions of the two elastic portions 43 are arranged oppositely along the long axis direction of the first magnetic portion 31. By increasing the spacing between the two elastic conductive members 4, the fixing position of the second connecting portion 42 of the elastic conductive member 4 with the diaphragm 21 can be effectively adjusted, further improving the fixing performance of the diaphragm 21. This makes the stress received by the elastic portion 43 during vibration of the sound generator 100 greatly reduced compared to a planar structure, significantly improving the vibration life of the elastic conductive member 4; meanwhile, the overall occupied planar space is greatly reduced, allowing for increased volume of other components and improved acoustic performance of the product.

In this embodiment, the voice coil 22 includes a pair of oppositely disposed long axial sides 221 and a pair of oppositely disposed short axial sides 223, at least one of the pair of long axial sides 221 is recessed toward another long axial side 221 to form a recessed portion 222; the first magnetic portion 31 and the second magnetic portion 32 are spaced apart to form the magnetic gap 34 matching with the shape of the pair of long axial sides 221; the first through hole 51 and the second through hole 52 are respectively disposed on opposite sides of the recessed portion 222 along the long axis direction of the first magnetic portion 31.

### Embodiment Three

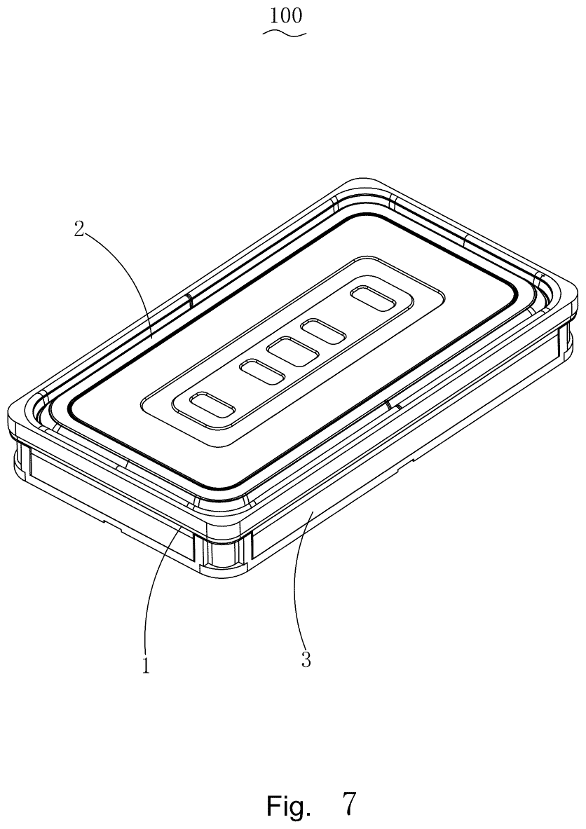

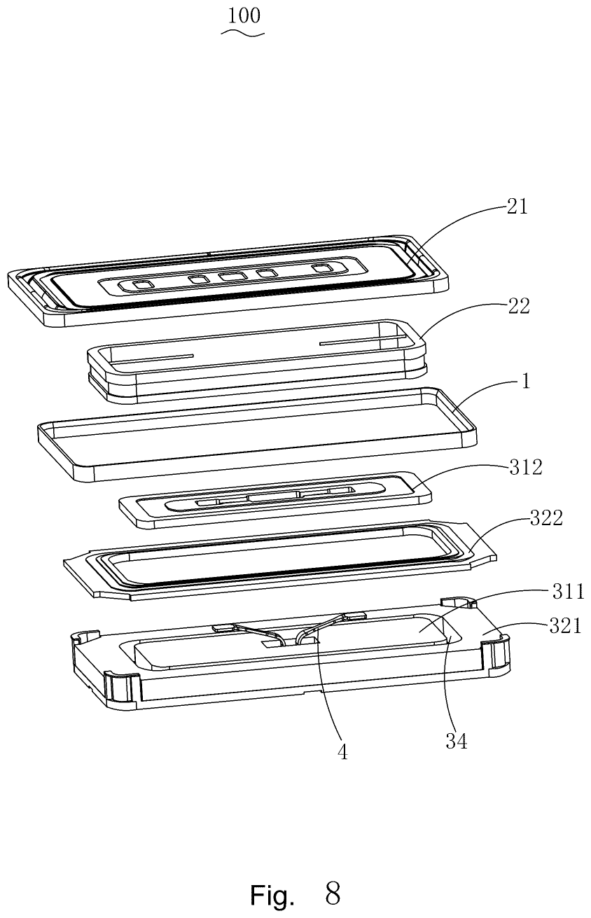

Please refer to FIGS. 7-8, this embodiment three is basically the same as embodiment one in structure, with the difference being that in this embodiment, the auxiliary magnet 321 is annular and is arranged around the main magnet 311 in a spaced manner. The auxiliary magnet 321 and the main magnet 311 are spaced apart to form the magnetic gap 34, providing high structural strength while enhancing the overall magnetic field of the magnetic circuit system 3, facilitating the driving of the voice coil 22.

### Embodiment Four

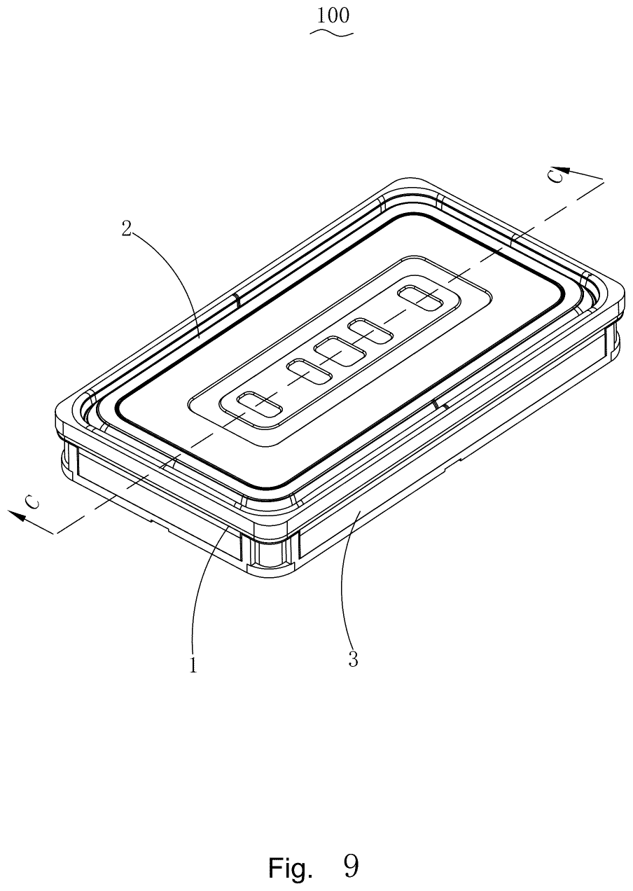

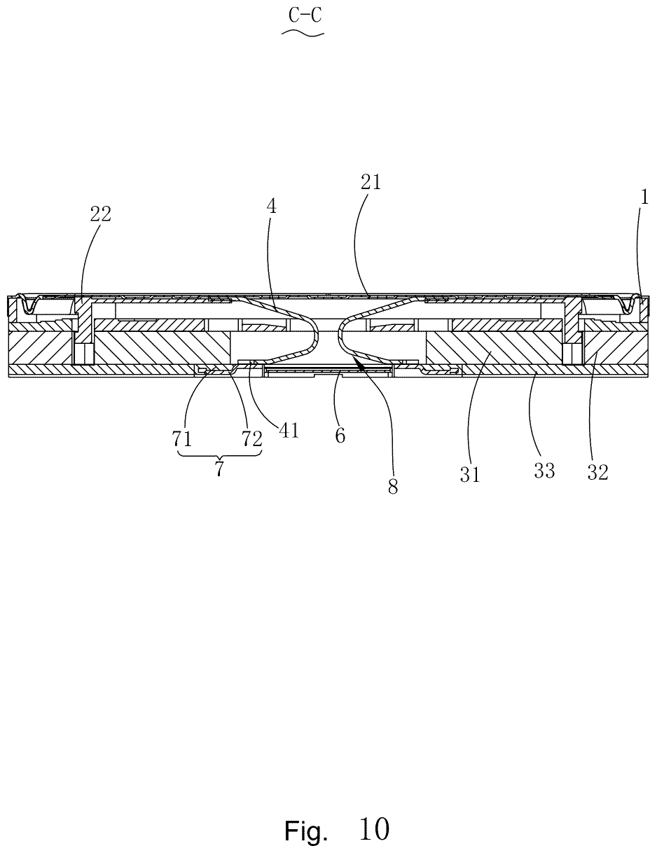

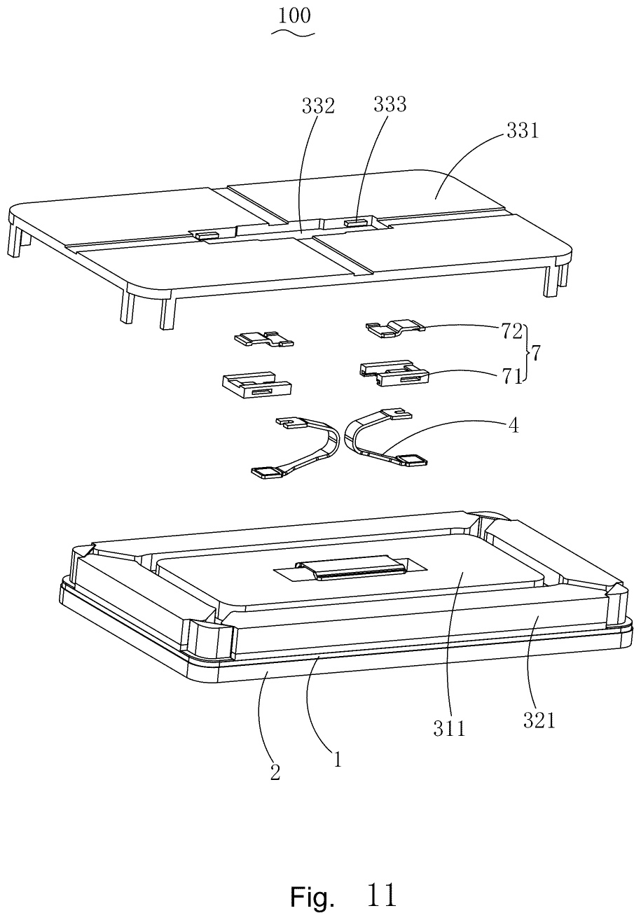

Please refer to FIGS. 9-11, this embodiment four is basically the same as embodiment one in structure, with the difference being that in this embodiment, the elastic conductive member 4 includes an elastic plate 8 electrically connected to the voice coil 22 and a transition assembly 7 electrically connected to the elastic plate 8 and fixed to a side of the first magnetic portion 31 away from the diaphragm 21 along the vibration direction. The transition assembly 7 includes a conductive connecting member 72 electrically connected to the elastic plate 8 and a plastic seal 71 injection-molded on the conductive connecting member 72. The elastic plate 8 includes the second connecting portion 42, the elastic portion 43, and a connecting end portion electrically connecting the elastic portion 43 and the conductive connecting member 72. The connecting end portion and the transition assembly 7 form the first connecting portion 41.

In this embodiment, the plastic seal 71 is fixed in the avoidance hole 332, and a side of the plastic seal 71 close to the sealing cover 6 abuts against the sealing cover 6. Installing the plastic seal 71 in the avoidance hole 332 and fixing the conductive connecting member 72 in the plastic seal 71 prevents signal interference caused by contact between the conductive connecting member 72 and the yoke 33. Connecting the conductive connecting member 72 to the first connecting portion 41 of the elastic conductive member 4 facilitates the extension of the conductive connecting member 72 to external power supply for powering the voice coil 22.

In this embodiment, the yoke 33 further includes a protruding portion 333 extending from a side wall of the avoidance hole 332 toward a mutually close side, and the plastic seal 71 and the protruding portion 333 are integrally formed by injection molding. This facilitates the filling of the plastic seal 71 in the avoidance hole 332, providing good overall sealing for the sound generator 100.

Compared with the prior art, in the sound generator of the present invention, by arranging the elastic conductive member at the inner side of the voice coil and extending through the first magnetic portion along the vibration direction of the diaphragm; the elastic conductive member including the first connecting portion, the second connecting portion, and the elastic portion elastically connecting the first connecting portion and the second connecting portion; the first connecting portion and the second connecting portion being respectively disposed on opposite sides of the first magnetic portion along the vibration direction, the first connecting portion being fixed to the side of the first magnetic portion away from the diaphragm, the second connecting portion being fixed to the side of the diaphragm close to the first magnetic portion and electrically connected to the voice coil; the elastic portion having a U-shaped structure and extending through the first magnetic portion while being spaced apart from the first magnetic portion; the stress received by the elastic portion during vibration is greatly reduced compared to a planar structure, significantly improving the vibration life of the elastic conductive member; meanwhile, the overall occupied planar space is greatly reduced, allowing for increased volume of other components and improved acoustic performance of the product.

The foregoing is merely illustrative of embodiments of the present invention, and it should be noted that modifications may be made to those skilled in the art without departing from the spirit of the invention but are intended to be within the scope of the inventio.

What is claimed is:

1. A sound generator, comprising:
a frame;
a vibration system comprising a diaphragm fixed to the frame and a voice coil configured to drive the diaphragm to vibrate and generate sound; and
a magnetic circuit system comprising a yoke fixed to a side of the frame away from the vibration system, a first magnetic portion stacked and fixed to a side of the yoke close to the diaphragm, and a second magnetic portion stacked and fixed to the side of the yoke close to the diaphragm and spaced apart from the first magnetic portion to form a magnetic gap; wherein the voice coil is inserted in the magnetic gap;
an elastic conductive member located at an inner side of the voice coil and extending through the first magnetic portion along a vibration direction of the diaphragm;
wherein
the elastic conductive member comprises a first connecting portion, a second connecting portion, and an elastic portion elastically connecting the first connecting portion and the second connecting portion;
the first connecting portion and the second connecting portion are respectively disposed on opposite sides of the first magnetic portion along the vibration direction;
the first connecting portion is fixed to a side of the first magnetic portion away from the diaphragm;
the second connecting portion is fixed to a side of the diaphragm close to the first magnetic portion and is electrically connected to the voice coil; and
the elastic portion has a U-shaped structure, the elastic portion extends through the first magnetic portion and is spaced apart from the first magnetic portion.

2. The sound generator as described in claim 1, further comprising a through hole formed through the first magnetic portion, wherein the elastic portion is disposed in the through hole.

3. The sound generator as described in claim 2, wherein the elastic conductive member comprises two elastic conductive members, the elastic portions of the two elastic conductive members are respectively disposed in the through hole, and opening directions of the two elastic portions are arranged oppositely along a long axis direction of the first magnetic portion.

4. The sound generator as described in claim 2, wherein the through hole comprises a first through hole and a second through hole that extend through the first magnetic portion and are spaced apart along the long axis direction of the first magnetic portion;
the elastic conductive member comprises two elastic conductive members, the elastic portions of the two elastic conductive members are respectively disposed in the first through hole and the second through hole, and opening directions of the two elastic portions are arranged oppositely along the long axis direction of the first magnetic portion.

5. The sound generator as described in claim 4, wherein the voice coil comprises a pair of oppositely disposed long axial sides and a pair of oppositely disposed short axial sides, at least one of the pair of long axial sides is recessed toward another long axial side to form a recessed portion; the first magnetic portion and the second magnetic portion are spaced apart to form the magnetic gap matching with the shape of the pair of long axial sides; the first through hole and the second through hole are respectively disposed on opposite sides of the recessed portion along the long axis direction of the first magnetic portion.

6. The sound generator as described in claim 1, wherein the first magnetic portion comprises a main magnet stacked and fixed to the side of the yoke close to the diaphragm and a main pole piece stacked and fixed to a side of the main magnet close to the diaphragm; the elastic conductive member successively extends through the main pole piece and the main magnet.

7. The sound generator as described in claim 6, wherein the second magnetic portion comprises an auxiliary magnet stacked and fixed to the side of the yoke close to the diaphragm and an auxiliary pole piece stacked and fixed to a side of the auxiliary magnet close to the diaphragm.

8. The sound generator as described in claim 7, wherein the auxiliary magnet comprises four auxiliary magnets, and the four auxiliary magnets are spaced apart to form an annular structure, the four auxiliary magnets are respectively arranged around an outer periphery of the main magnet and spaced apart to form the magnetic gap.

9. The sound generator as described in claim 7, wherein the auxiliary magnet is annular and is arranged around the main magnet in a spaced manner.

10. The sound generator as described in claim 2, wherein the yoke comprises a yoke body fixed to the frame and an avoidance hole formed through the yoke body, the avoidance hole communicates with the through hole;
the sound generator further comprises a sealing cover covering the through hole, the sealing cover and the first connecting portion are respectively disposed in the avoidance hole.

11. The sound generator as described in claim 10, wherein the elastic conductive member comprises an elastic plate electrically connected to the voice coil and a transition assembly electrically connected to the elastic plate and fixed to a side of the first magnetic portion away from the diaphragm along the vibration direction, the transition assembly comprises a conductive connecting member electrically connected to the elastic plate and a plastic seal injection-molded on the conductive connecting member, the elastic plate comprises the second connecting portion, the elastic portion and a connecting end portion electrically connecting the elastic portion and the conductive connecting member, the connecting end portion and the transition assembly form the first connecting portion.

12. The sound generator as described in claim 11, wherein the plastic seal is fixed in the avoidance hole, a side of the plastic seal close to the sealing cover abuts against the sealing cover.

13. The sound generator as described in claim 11, wherein the yoke further comprises a protruding portion extending from a side wall of the avoidance hole toward a mutually close side, the plastic seal and the protruding portion are integrally formed by injection molding.

14. The sound generator as described in claim 1, wherein the diaphragm comprises an annular suspension, a fastening portion extending from an outer periphery of the suspension toward the frame, a vibration portion extending from an inner periphery of the suspension away from the frame, and a dome fixed to a side of the vibration portion close to the magnetic circuit system; the voice coil is fixed to a side of the dome close to the magnetic circuit system; the second connecting portion is fixed to the side of the dome close to the magnetic circuit system.
